(19) United States
(12) Patent Application Publication
(10) Pub. No.: US 2010/0283780 A1
(43) Pub. Date: Nov. 11, 2010

(54) INFORMATION PROCESSING APPARATUS, INFORMATION PROCESSING METHOD, AND STORAGE MEDIUM

(75) Inventor: Seiji Ohmori, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/770,579

(22) Filed: Apr. 29, 2010

(30) Foreign Application Priority Data
May 7, 2009 (JP) 2009-113026

(51) Int. Cl. G06T 15/00

(52) U.S. Cl. 345/419

(57) ABSTRACT

There is provided an information processing apparatus that enables three-dimensional rendering of an image corresponding to two-dimensional vector-based data with a relatively simple technique. The information processing apparatus includes a first generation unit configured to generate from vector-based graphics data a first coordinate data group at boundary portions of a first image to be rendered based on the graphics data, a second generation unit configured to generate a second coordinate data group by applying a graphics conversion rule to the first coordinate data group to transform the first image to obtain a second image, and a rendering unit configured to render the second image in bitmap form based on the second coordinate data group.

### BACKGROUND OF THE INVENTION

1. Field of the Invention

The present invention relates to a technique for converting an image of vector-based graphics data into other forms.

2. Description of the Related Art

In recent years, with the increase in the use of a high definition multi-color display screen on information processing apparatuses having display functions, the use of a graphical user interface (GUI) having high visual effects is also increasing.

A known method arranges two-dimensional windows in a virtual three-dimensional space to provide visual effects on the GUI (for example, refer to Japanese Patent Application Laid-Open No. 11-65806). Another known method displays two-dimensional data in three-dimensional form (for example, refer to Japanese Patent Application Laid-Open No. 2002-358541).

Japanese Patent Application Laid-Open No. 11-65806 discusses a technique for converting two-dimensional windows into three-dimensional form based on texture mapping. Japanese Patent Application Laid-Open No. 2002-358541 discusses a technique for converting two-dimensional text and graphics data into three-dimensional form based on triangulation of a two-dimensional convex hull.

However, there has been a problem that the above-mentioned conversion processing based on the texture mapping or triangulation requires a large amount of calculations and therefore is time consuming. The texture mapping requires color information calculation for texture subjected to mapping by using color information of each pixel constituting texture. Therefore, the larger a graphics object, the larger the amount of calculations.

Particularly when original graphics data is two-dimensional vector data, it is necessary for these conventional methods to generate texture before conversion process. Further, when the triangulation is used, an increase in the number of line segments constituting the original graphics data causes a dramatic increase in the number of divisions and accordingly an increase in the amount of calculations. There have been cases where prolonged processing time for rendering causes, for example, rendering speed reduction or frame missing in animation rendering.

### SUMMARY OF THE INVENTION

According to an aspect of the present invention, an information processing apparatus includes a first generation unit configured to generate from vector-based graphics data a first coordinate data group at boundary portions of a first image to be rendered based on the graphics data, a second generation unit configured to generate a second coordinate data group by applying a graphics conversion rule to the first coordinate data group to transform the first image to obtain a second image, and a rendering unit configured to render the second image in bitmap form based on the second coordinate data group.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an information processing apparatus according to a first exemplary embodiment.

FIG. 2 illustrates an exemplary GUI screen displayed on a display unit.

FIG. 3 illustrates apart of scalable vector graphics (SVG) data for generating the GUI screen in FIG. 2.

FIG. 4 is a flow chart illustrating processing performed by the information processing apparatus according to the first exemplary embodiment.

FIG. 5 illustrates a part of SVG data before applying the processing of the flow chart in FIG. 4 thereto.

FIG. 6 illustrates SVG data obtained by applying the processing of step S401 to the SVG data in FIG. 5.

FIG. 7 illustrates SVG data obtained by applying the processing of step S402 to the SVG data in FIG. 6.

FIG. 8 illustrates a part of SVG data before applying the processing of the flow chart in FIG. 4 thereto.

FIG. 9 illustrates SVG data obtained by applying the processing of step S402 to the SVG data in FIG. 8.

FIG. 10 is a schematic view of a concept of perspective transformation, which is a coordinate conversion method used in step S403.

FIGS. 11A and 11B illustrate SVG data and rendering result on the screen, respectively, obtained by applying the processing of step S403 to the SVG data in FIG. 7.

FIGS. 12A and 12B illustrate data and rendering result on the screen, respectively, obtained by applying the processing of step S403 to the SVG data in FIG. 9.

FIG. 13 illustrates rendering result on the screen obtained by applying the processing of steps S401 to S403 to each rendering object in data in FIGS. 2 and 3.

FIG. 14 illustrates path data generated insteps S404 and S405 in FIG. 4.

FIG. 15 illustrates rendering result on the screen obtained by applying the processing of the flow chart in FIG. 4 to the data in FIGS. 2 and 3.

FIG. 16 illustrates exemplary animation display according to a second exemplary embodiment.

FIG. 17 is a flow chart illustrating processing performed by an information processing apparatus according to the second exemplary embodiment.

FIGS. 18A and 18B illustrate a rectangle before conversion process is applied according to a fourth exemplary embodiment.

FIG. 19A illustrates an exemplary SVG description for the rectangle in FIG. 18A, and FIG. 19B illustrates an exemplary SVG description obtained by applying coordinate conversion to a part of the rectangle.

FIGS. 20A to 20C illustrate rendering result on the screen obtained by applying coordinate conversion to the rectangles in FIGS. 18A and 18B.

FIG. 21 is a flow chart illustrating processing performed by the information processing apparatus according to the fourth exemplary embodiment.

FIG. 22 illustrates rendering result on the screen obtained by applying a conversion that converts areas surrounding similar colors into one piece of path data.

FIG. 23 is a flow chart illustrating processing performed by an information processing apparatus according to a fifth exemplary embodiment.

FIGS. 24A and 24B illustrate a change of a rendering object obtained by applying the processing of steps S2302 and S2303.

### DESCRIPTION OF THE EMBODIMENTS

Various exemplary embodiments, features, and aspects of the invention will be described in detail below with reference to the drawings.

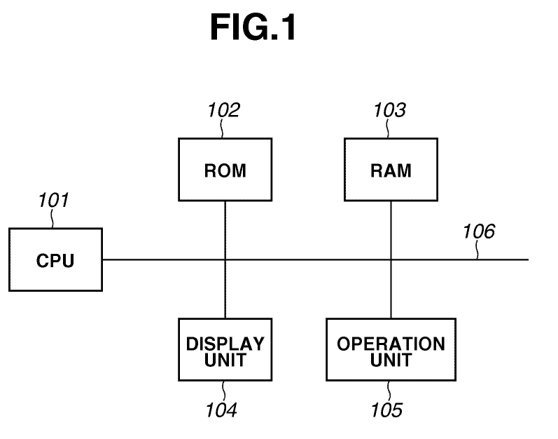

A first exemplary embodiment will be described below. FIG. 1 is a block diagram illustrating a configuration of an information processing apparatus according to a first exemplary embodiment.

Referring to FIG. 1, the central processing unit (CPU or processing unit or processor) 101 is a system controller that controls the entire information processing apparatus. A read-only memory (ROM) 102 is a memory unit dedicated for storing control programs for the CPU 101 as well as various fixed data. A random access memory (RAM) 103 is a rewritable memory unit including a static RAM (SRAM), a dynamic RAM (DRAM), etc. for storing program control variables as well as various setup parameters and working buffers.

A display unit 104 such as a liquid crystal display (LCD) unit displays data to an operator. An operation unit 105 including a keyboard, a pointing device, etc. is used by the operator to perform various input operations. A system bus 106 connects these units 101 to 105 to enable communication therebetween.

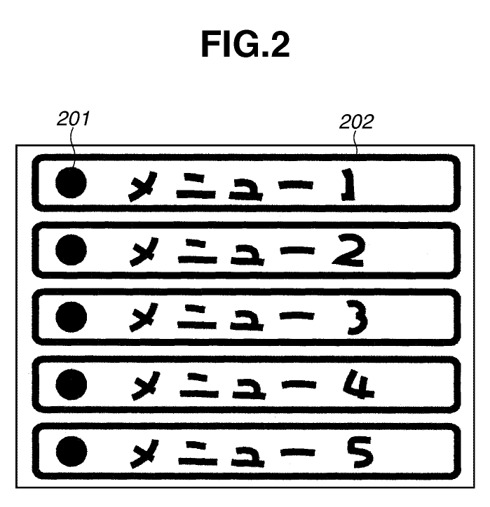

FIG. 2 illustrates an exemplary GUI screen displayed on the display unit 104.

The information processing apparatus according to the present exemplary embodiment uses graphics data of the scalable vector graphics (SVG) format (hereinafter referred to as SVG data) as GUI screen data. SVG is a two-dimensional vector-based graphics format described with the extensible markup language (XML). In SVG data, each rendering object is described as the XML element. For example, an ellipse is described as the ellipse element and a rectangle is described as the rect element.

When displaying a GUI screen, the information processing apparatus analyzes SVG data prestored in the ROM 102, and converts it into an internal data format having the same information as SVG data. The internal data format is referred to as document object model (DOM). The information processing apparatus converts DOM data into image data before displaying it on the display unit 104. Although the GUI screen displays the graphics data in binary format (black and white) in FIG. 2, it may be a color screen.

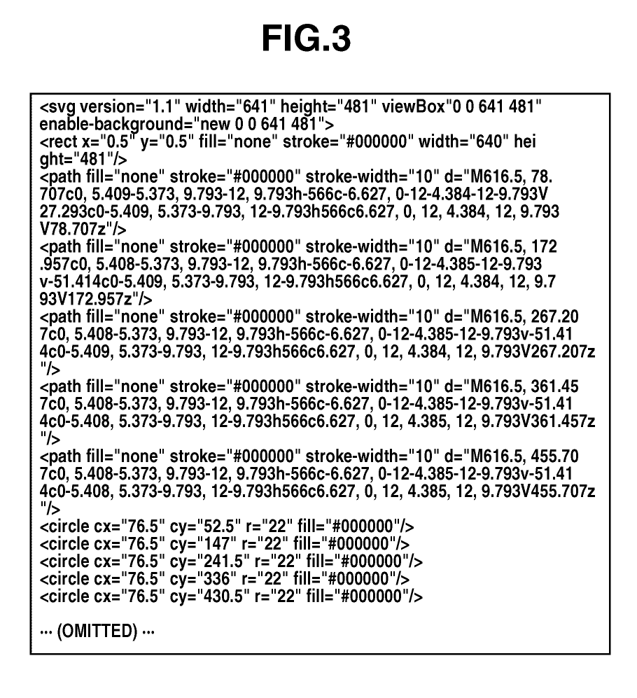

FIG. 3 illustrates a part of SVG data for generating the GUI screen in FIG. 2. SVG data is data in vector-based graphics format that can expresses the shape, rendering coordinates, size, a fill color, etc. of a rendering object with numeric values and character strings, as illustrated in FIG. 3.

Referring to the SVG data in FIG. 3, “path” means a line and “circle” means a circle. The stroke-width attribute in each path element denotes the thickness of the line, and the d attribute therein denotes curves and line segments constituting the line. Numeric values appearing in attribute values of the d attribute in each path element are coordinate values, and alphabetical characters appearing therein are commands meaning second order Bezier curves, third order Bezier curves, and line segments. The fill attribute in each circle element denotes the fill color of the circle.

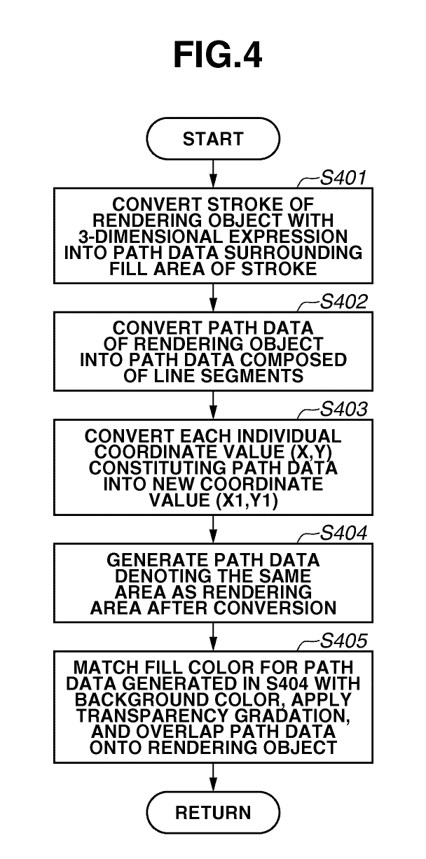

FIG. 4 is a flow chart illustrating processing performed by the information processing apparatus according to the present exemplary embodiment.

The information processing apparatus reads the SVG data in FIG. 3, and converts it into DOM data in the internal data format. The processing illustrated in the flow chart in FIG. 4 is performed by operating and editing the DOM data after converting SVG data into DOM data. The information processing apparatus performs the processing in FIG. 4 to enable giving three-dimensional visual effects to the GUI screen in FIG. 2.

In SVG data, for example, the circle element for rendering a circle specifies coordinate values of the central point, a radius, and a fill color. When coordinate values of this central point are converted into different coordinate values, the circle remains a circle, and rendering involving three-dimensional modification is not possible. However, the processing of the flow chart in FIG. 4 enables rendering with three-dimensionally expression.

Referring to FIG. 4, in step S401, the CPU 101 converts the stroke of a rendering object to be three-dimensionally expressed into path data surrounding the fill area of the stroke. The stroke refers to line data having a thickness. Each piece of data denoted by the path element in the SVG data in FIG. 3 is a stroke.

In step S401, the CPU 101 converts (generates) such stroke data into path data containing coordinate data groups containing a plurality of pieces of coordinate data. The path data refers to data denoting an area surrounded by lines having a thickness of zero (0). The lines may include a curve. In the path data, a fill color and transparency for filling the area can be specified.

Although path data denoting boundary portions of the image in FIG. 2 to be rendered is generated from the SVG data illustrated in the FIG. 2 in the present exemplary embodiment, the target data is not limited to path data as long as it is an expression containing coordinate data groups but may be, for example, edge coordinate groups for each scan line.

In step S402, the CPU 101 converts the path data of the rendering object into path data composed only of line segments. The initial SVG data and the path data converted in step S401 may contain a curve therein. The processing of step S402 converts the path data into data wherein all curves are composed only of line segments.

Converting a curve into line segments may degrade the image quality. However, the degradation of image quality will not become problematic if the curve is divided into minute curves and each minute curve is replaced with an approximated line segment.

In SVG data, the circle element denoting a circle does not have path data descriptions of the rendering object. In this case, the CPU 101 calculates path data and then converts it into path data composed only of line segments in step S402. The number of divisions of path data may be determined based on a predetermined rule (tolerance rule).

The less the number of divisions (number of coordinate data groups) in path data generated in steps S401 and S402, the less the total load for calculations while the lower becomes the approximation accuracy. Therefore, the tolerance rule is determined by the resolution of the display unit 104, calculation load on the CPU 101, and user's intention.

In step S403, the CPU 101 converts each individual coordinate value (x, y) constituting each piece of path data into a new coordinate value (x1, y1) based on a predetermined graphics conversion rule. Specifically, a second coordinate data group is generated by applying a graphics modification rule to a first coordinate data group. The processing of step S403 aims to perform coordinate conversion so that each piece of path data may look in three-dimensional form. The step 403 performs coordinate conversion (perspective transformation) using perspective projection.

In step S404, the CPU 101 generates path data denoting the same area as the rendering area of the rendering object after applying the coordinate conversion process of steps S401 to S403.

In step S405, the CPU 101 overlaps the path data onto the rendering object after conversion process. In S405, the CPU 101 also matches the fill color of the path data generated in step S404 with the background color, and applies transparency gradation to the path data. This processing provides such effects that decrease color strength and brightness with increasing depth from the rendering surface, enabling more three-dimensionally expression.

New DOM data is generated by the processing of steps S401 to S405. In the processing of steps S401 to S405, the CPU 101 may process rendering objects to be three-dimensionally expressed in succession or collectively process a plurality of objects.

After completion of the processing of the flow chart in FIG. 4, the CPU 101 converts the DOM data into bitmap image data, and then displays it on the display unit 104. Specifically, the CPU 101 performs image rendering process based on the path data generated in steps S401 to S405, and then displays it on the display unit 104.

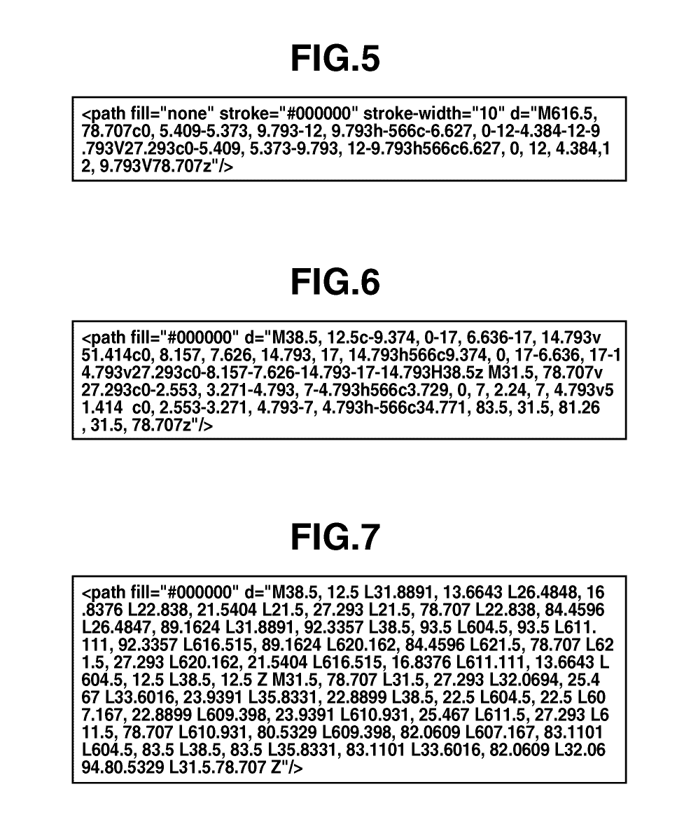

FIGS. 5 to 9 illustrate a series of changes of SVG data by the processing of steps S401 and S402. FIGS. 5 to 9 illustrate SVG-based text data for convenience of descriptions. Actually, the processing of the flow chart in FIG. 4 changes the DOM data retained in the RAM 103.

FIG. 5 illustrates a part of SVG data before applying the processing of the flow chart in FIG. 4 thereto. More specifically, FIG. 5 illustrates a part of the SVG data described by the path element for rendering a line having a thickness.

FIG. 6 illustrates SVG data obtained by applying the processing of step S401 to the SVG data in FIG. 5.

Apparently, the SVG data in FIG. 6 has a larger amount of data than that illustrated in FIG. 5 because the stroke data having a thickness is converted into path data surrounding the fill area (data composed of coordinate data groups at boundary portions of the fill area). The SVG data in FIG. 5 includes “10” as the value of the stroke-width attribute described in the path element. This means that the thickness of the stroke (line) is 10 pixels.

The stroke-width attribute disappears from the SVG data in FIG. 6. This means that the thickness of the line is zero (0). The SVG data in FIG. 5 includes “#000000” as the value of the stroke attribute described in the path element. This means that the color of the line is black. In the SVG data in FIG. 6, it is replaced with the value of the fill attribute, i.e., the fill color. The above-mentioned stroke data is exemplary application of graphics data.

FIG. 7 illustrates SVG data obtained by applying the processing of step S402 to the SVG data in FIG. 6. A Bezier curve is a curve defined by endpoints, tangent lines, and control points at the ends of the tangent lines. Altering the length and angle of tangent lines alters the shape of the curve. Apparently, the SVG data in FIG. 7 has a larger amount of data than that illustrated in FIG. 6 because a Bezier curve that can be expressed by three or four sets of coordinate values is divided into minute line segments based on the tolerance rule.

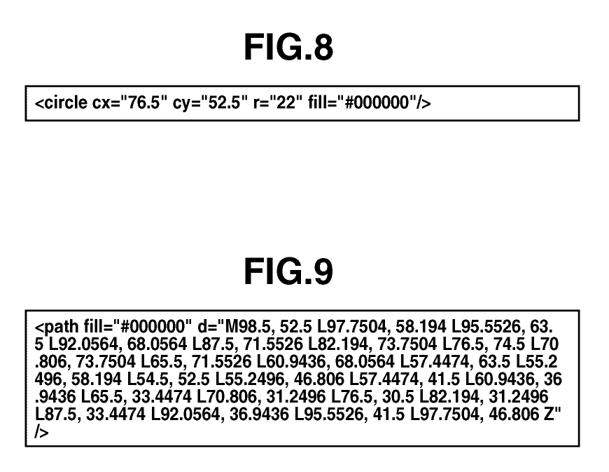

FIG. 8 illustrates a part of SVG data before applying the processing of the flow chart in FIG. 4 thereto. More specifically, FIG. 8 illustrates a part of the SVG data described in the circle element for rendering a circle. As illustrated in FIG. 8, in SVG data, the description of a circle includes coordinate values of the central point, a radius, and a fill color.

FIG. 9 illustrates SVG data obtained by applying the processing of step S402 to the SVG data in FIG. 8. The circle element in FIG. 8 does not include the description of the stroke-width attribute. This means that the width of the circumference stroke is zero (0). Therefore, the SVG data remains unchanged even after applying the processing of step S401 thereto.

As a result of the processing of step S402, the circle element in FIG. 8 is replaced with the path element in FIG. 9. The SVG data in FIG. 8 describes only the radius of the circle and does not describe path data denoting its circumference. The processing of step S402 calculates path data of the circumference and then converts the path data into path data composed only of line segments. The values of the d attribute of the SVG data in FIG. 9 denote the circumference. This path data is composed of a set of line segments.

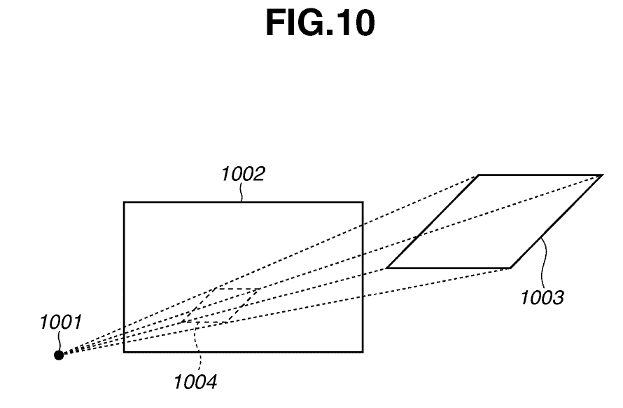

FIG. 10 is a schematic view of a concept of perspective transformation, which is a coordinate conversion method used in step S403.

A three-dimensional virtual space illustrated in FIG. 10 includes a projection center 1001, a projection surface (plane) 1002, a projection target 1003, and a rendering object 1004. The projection center 1001 corresponds to the view point of a viewer. The projection surface (plane) 1002 corresponds to the screen of the display unit 104. The projection target 1003 corresponds to a graphics rendering object according to the present exemplary embodiment. The rendering object 1004 under perspective projection is composed of intersections of straight lines connecting the projection center 1001 and apexes of the projection target 1003, and the projection surface 1002.

The coordinate conversion process of step S403 converts coordinate values constituting the rendering object 1004 of the projection target 1003 into coordinate values constituting the rendering object 1004 on the projection surface 1002. Although perspective transformation is employed in the present exemplary embodiment, other coordinate conversion methods may be used in the processing of step S403.

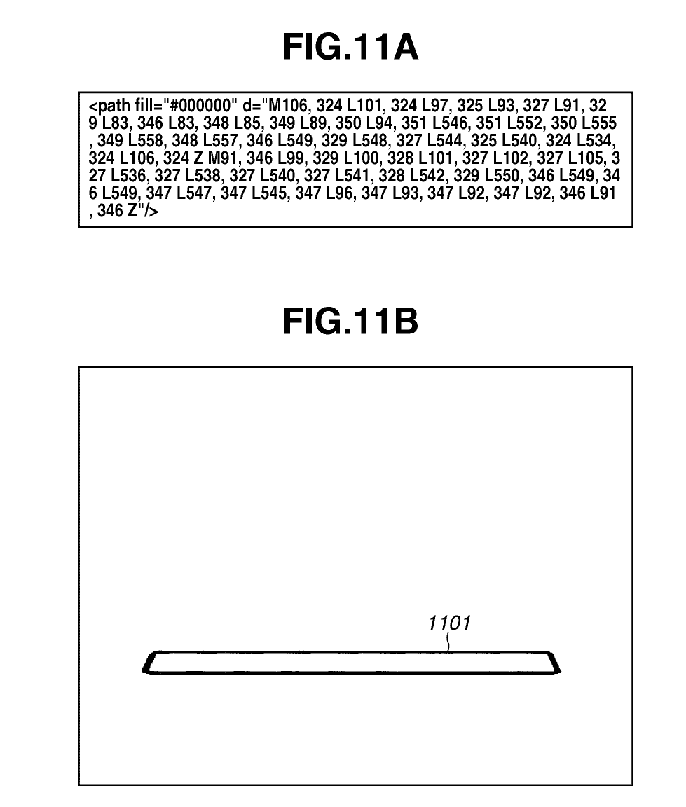

FIG. 11A illustrates SVG data obtained by applying the processing of step S403 to the SVG data in FIG. 7. FIG. 11B illustrates rendering result on the screen for the SVG data in FIG. 11A.

Since each individual coordinate value is changed in step S403, the number of coordinate values in the SVG data in FIG. 7 coincides with the number of those described in the d attribute in the SVG data in FIG. 11. A character string “M38.5, 12.5” at the beginning of the d attribute in the SVG data in FIG. 7 means that the path data starts from a coordinate (x, y)=(38.5, 12.5).

Since this coordinate value is converted into (x, y)=(106, 324) after applying the processing of step S403, the d attribute in the SVG data in FIG. 11 starts with “M106, 324”. After applying such conversion process to each individual coordinate value described in the d attribute in the SVG data in FIG. 7, the coordinate values are converted into the path element in FIG. 11A. This provides such a three-dimensional expression that the rendering object is turned over toward the depth direction (Z direction) as illustrated in FIG. 11B.

A rendering object 1101 in FIG. 11B is obtained by applying the processing of steps S401 to S403 to the data 202 in FIG. 2.

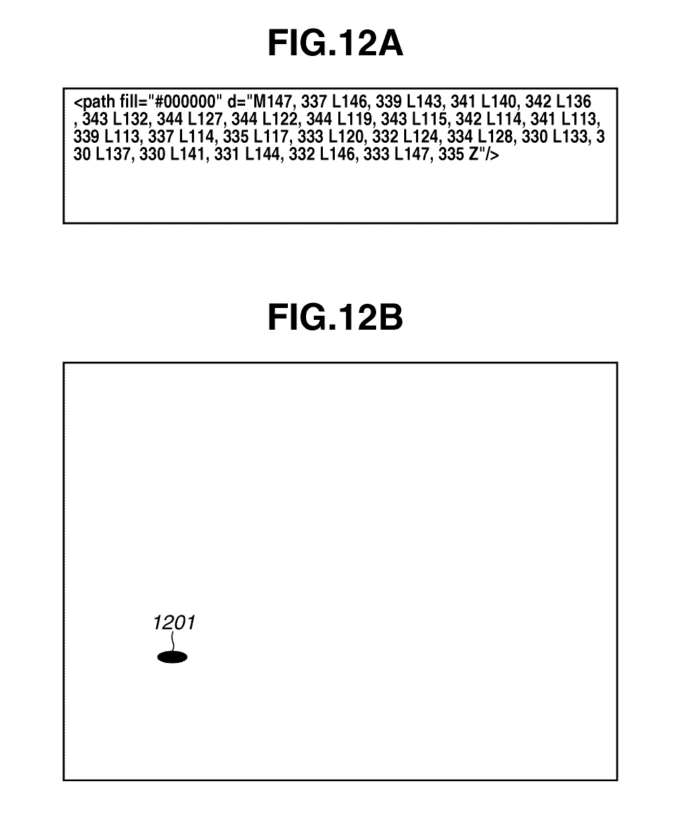

FIG. 12A illustrates SVG data obtained by applying the processing of step S403 to the SVG data in FIG. 9. FIG. 12B illustrates rendering result on the screen based on the SVG data in FIG. 12A.

The number of coordinate values described in the SVG data in FIG. 9 coincides with the number of those in the SVG data in FIG. 12. Although the SVG data in FIG. 8 denotes a circle described in the circle element, the rendering result on the screen in FIG. 12B is obtained by applying the processing of steps S402 and S403. A rendering object 1201 in FIG. 12B is resulted by applying the processing of steps S401 to S403 to data 201 in FIG. 2.

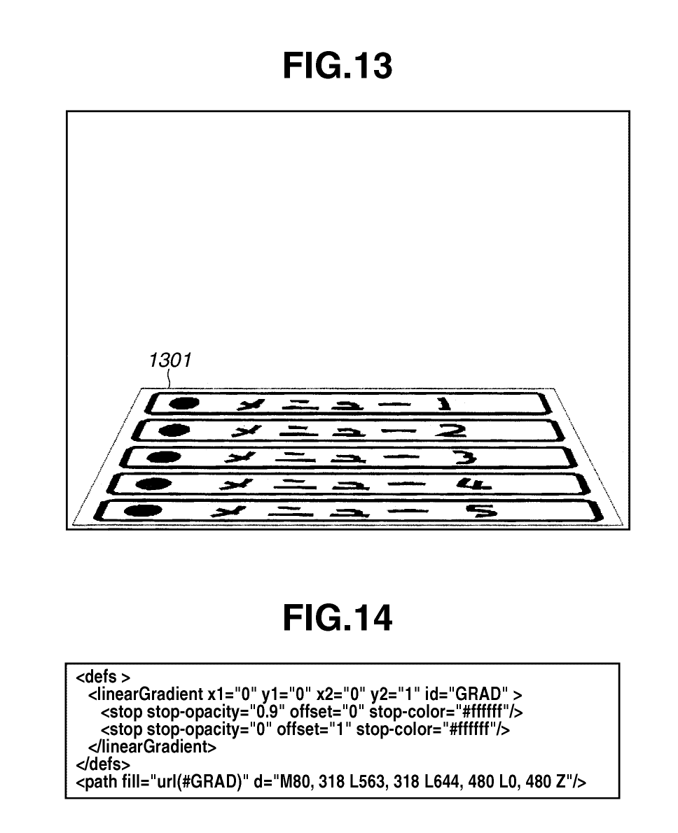

FIG. 13 illustrates rendering result on the screen obtained by applying the processing of steps S401 to S403 to each rendering object in data in FIGS. 2 and 3. As illustrated by a rendering object 1301 in FIG. 13, applying the processing of steps S401 to S403 to each rendering object in FIG. 2 provides such a three-dimensionally expression that the rendering surface is turned over toward the depth direction.

FIG. 14 illustrates path data generated insteps S404 and S405 in FIG. 4.

A rendering area described in the path element in FIG. 14 coincides with the rendering area obtained by applying the conversion process of the steps S401 to S403 (the rendering object 1301 in FIG. 13). This path element is filled in white, which is the same color as the background color, and transparency gradation is applied. The fill color and transparency gradation are described in the defs element in FIG. 14.

Transparency gradation is a method for filling a rendering area while gradually changing transparency therein. Gradation described in the path data in FIG. 14 is such that positions closer to the bottom of the screen have larger transparency. In step S404, the CPU 101 generates the path element in the SVG data in FIG. 14. In step S405, the CPU 101 generates the defs element in the SVG data in FIG. 14 and adds it to DOM data corresponding to FIG. 13.

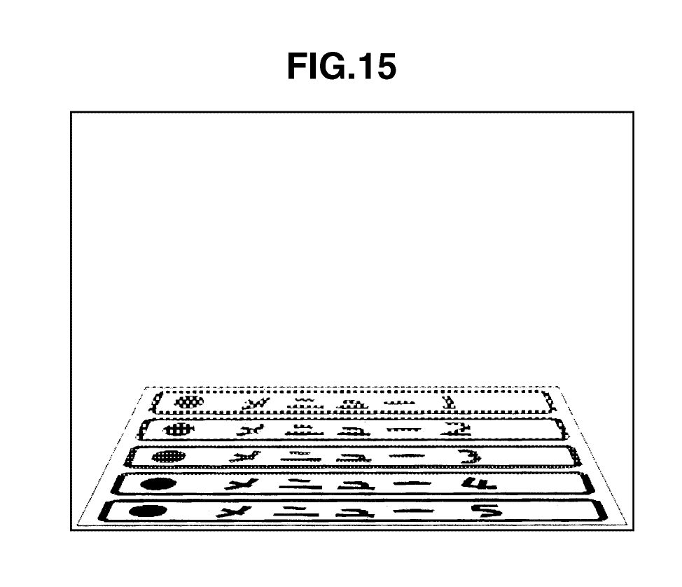

FIG. 15 illustrates rendering result on the screen obtained by applying the processing of the flow chart in FIG. 4 to the data in FIGS. 2 and 3.

FIG. 15 expresses gradation in a simple way. As illustrated in FIG. 15, adding the SVG data in FIG. 14 increases a feeling of depth, enabling more three-dimensionally expression than FIG. 13. Although the path element is filled with the same color as the background color in the present exemplary embodiment, it is also possible to fill it black and apply transparency gradation to decrease brightness with increasing depth from the rendering surface.

As described above, applying the processing according to the present exemplary embodiment to two-dimensional vector-based graphics data enables the three-dimensionally rendering for the two-dimensional vector-based graphics data in a relatively simple way.

Although the processing of the flow chart in FIG. 4 is applied to all the rendering objects of the data in FIGS. 2 and 3 in the present exemplary embodiment, the processing in FIG. 4 may be applied only to some rendering objects. This enables such an expression that apart of graphics data is turned over toward the depth direction.

A second exemplary embodiment will be described below. The configuration of an information processing apparatus according to the second exemplary embodiment is the same as that of the information processing apparatus according to the first exemplary embodiment in FIG. 1. The present exemplary embodiment will specifically be described based on animation display using the graphics data in FIGS. 2 and 3.

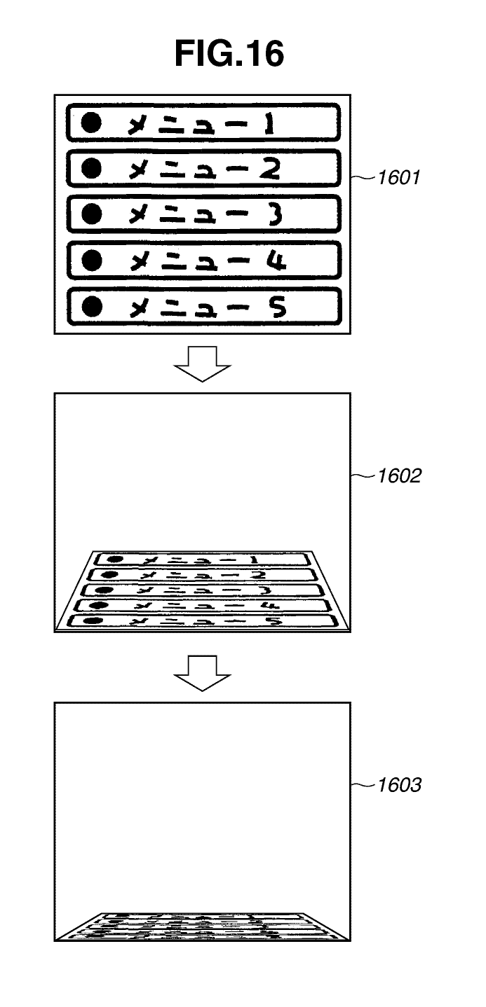

FIG. 16 illustrates exemplary animation display according to the second exemplary embodiment. Suppose that animation display is made for 1 second. Referring to FIG. 16, an animation display 1601 illustrates the state of the animation at zero (0) second at which animation is started, an animation display 1602 illustrates the state of the animation at 0.5 seconds, and an animation display 1603 illustrates the state of the animation at 1 second at which animation is stopped.

Each of the above-mentioned animation displays is referred to as a frame. When the information processing apparatus performs rendering at 100-milisecond intervals, there are several frames between the displays 1601 and 1602 in FIG. 16. The same is applied to between the displays 1602 and 1603. Animation illustrated in FIG. 16 requires the coordinate conversion process for each frame.

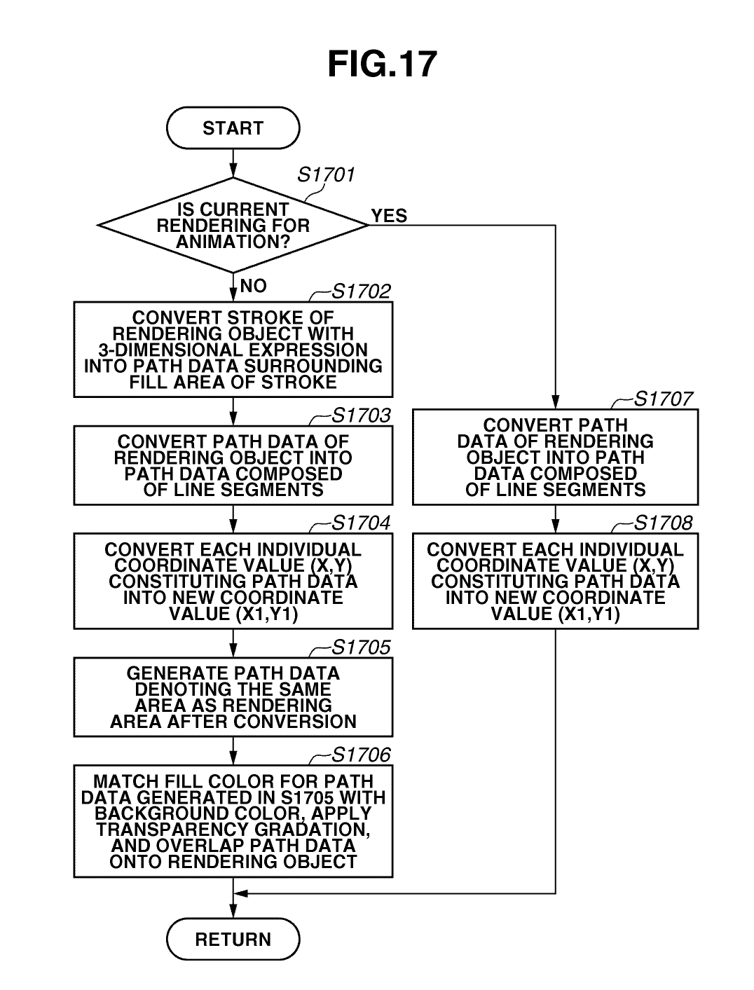

FIG. 17 is a flow chart illustrating processing performed by the information processing apparatus according to the present exemplary embodiment. The CPU 101 performs the processing in FIG. 17 after starting animation, i.e., when rendering frames at zero (0) second and after.

As illustrated in FIG. 17, in step S1701, the CPU 101 determines whether or not the current rendering frame is for animation in progress. When the rendering time is larger than zero (0) second and smaller than 1 second, the CPU 101 determines that the current rendering frame is for animation in progress. Step S1701 is exemplary processing performed by a determination unit.

When the CPU 101 determines that the current rendering frame is not for animation in progress (NO in step S1701), the CPU 101 proceeds to steps S1702 to S1706. The processing of steps S1702 to S1706 is similar to that of steps S401 to S405 in FIG. 4.

When the CPU 101 determines that the current rendering frame is for animation in progress (YES in step S1701), the CPU 101 proceeds to step S1707 to convert the path data of the rendering object into path data composed of only line segments.

Then, the CPU 101 proceeds to step S1708 to convert each individual coordinate value (x, y) constituting each piece of path data into a new coordinate value (x1, y1) by using a predetermined formula. This coordinate conversion method is similar to that described in the first exemplary embodiment. Further, the processing of steps S1707 and S1708 is similar to that of steps S1703 and 1704, respectively. After completion of the processing of the flow chart in FIG. 17, the CPU 101 performs rendering in the display unit 104.

As illustrated in FIG. 17, the CPU 101 does not perform the processing of steps S1702 and S1705, and reduces the amount of rendering process during animation, thus attaining higher rendering speeds. This processing enables avoiding rendering speed reduction and frame missing in animation rendering as much as possible. During animation display, since each frame is displayed for a short time period, a visual discomfort can be minimized.

Although the processing of steps S1707 and S1708 is performed for each frame during animation in the present exemplary embodiment, the processing of step S1707 may be performed before starting animation. Thus, it is only necessary to perform the processing of step S1708 during animation.

Further, although the CPU 101 determines whether or not rendering process is reduced (whether or not rendering is made with high definition) according to whether the current rendering frame is for animation in progress in the present exemplary embodiment, it may be determined based on other states of the information processing apparatus or the type of graphics data. For example, rendering process may be reduced when a large load is applied to the CPU 101 because of parallel processing or when there are many rendering objects to be converted.

Although the first and second exemplary embodiments have specifically been described based on an information processing apparatus having the display unit 104, these exemplary embodiments are applicable to any apparatuses having a printer, a camera, a copying machine, a scanner, and a display unit.

A third exemplary embodiment will be described below. The configuration of an information processing apparatus according to the third exemplary embodiment is the same as that of the information processing apparatus according to the first exemplary embodiment in FIG. 1. In the first exemplary embodiment, the CPU 101 converts the DOM data generated by the processing of steps S401 to S405 into bitmap image data, and then displays it on the display unit 104. However, before converting into bitmap data, SVG data may be output based on the path data generated in step S404. The present exemplary embodiment enables holding data (after applying the graphics conversion rule) not as bitmap data but as small sized SVG data (vector-based data).

A fourth exemplary embodiment will be described below. The configuration of an information processing apparatus according to the fourth exemplary embodiment is the same as that of the information processing apparatus according to the first exemplary embodiment in FIG. 1.

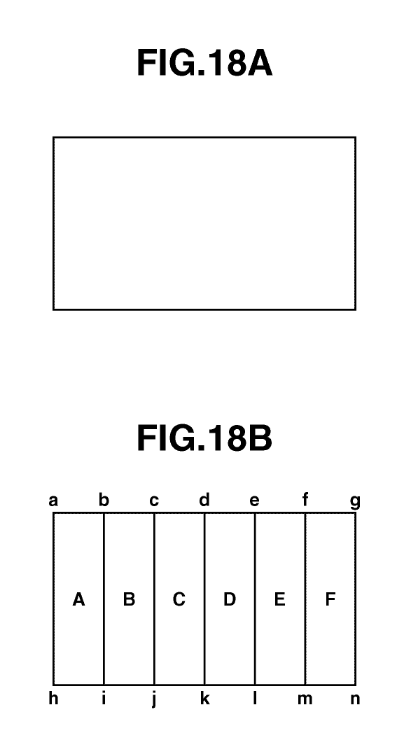

FIG. 18A illustrates a rectangle before applying the coordinate conversion process. Although sides (frame lines) of the rectangle are drawn in FIG. 18A for convenience sake, it actually has no sides and rectangular areas are filled. FIG. 18B illustrates how the rectangle in FIG. 18A is filled. This rectangle is defined so as to be filled with horizontal color gradation.

As illustrated in FIG. 18B, a rectangular area “abih” is filled with a color A, and subsequent rectangular areas are respectively filled with colors B, C, D, E, and F. Although only six colors are used in FIG. 18B for convenience of description, more colors are generally used in actual gradation rendering.

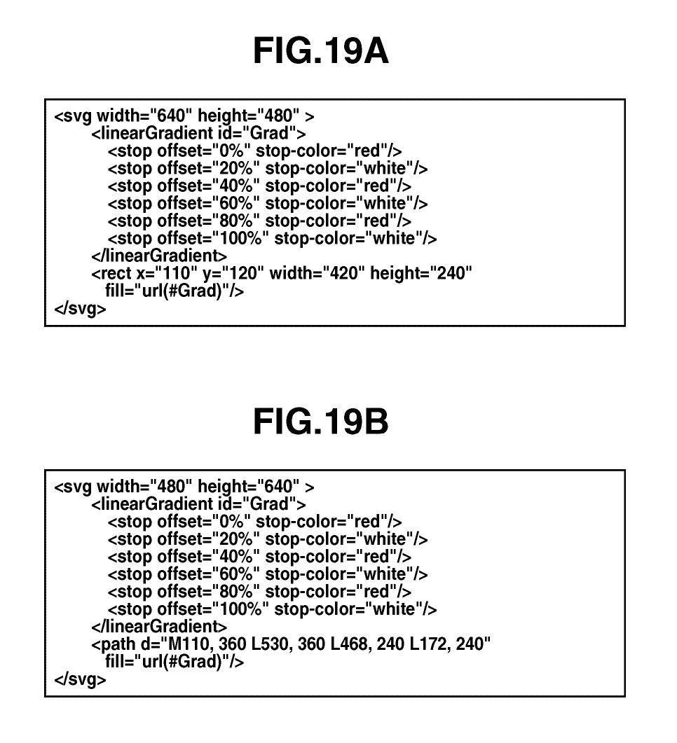

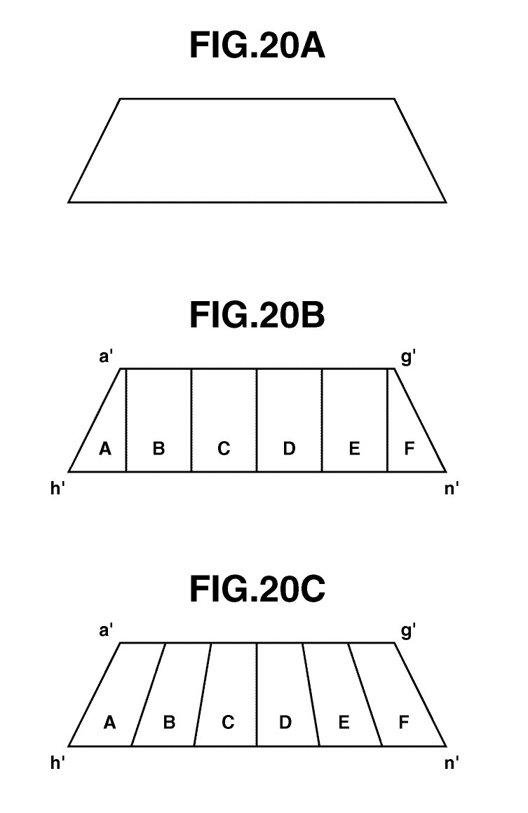

FIG. 19A illustrates an exemplary SVG description for the rectangle in FIG. 18A. As illustrated in 19A, in SVG data, it is possible to specify gradation-based filling for a rectangular area. FIG. 19B illustrates an exemplary SVG description obtained by applying coordinate conversion to each of apexes defining the shape of the rectangle in FIG. 18. As illustrated in FIG. 19B, although coordinate conversion is applied to the portions defining the shape, the definition of gradation remains unchanged. Therefore, the rendering on the screen is as illustrated in FIG. 20B below.

FIG. 20A illustrates rendering result on the screen obtained by applying coordinate conversion to the rectangle in FIG. 18. With SVG, simply converting each individual coordinate value constituting the rectangle as illustrated in FIG. 19B causes rendering on the screen illustrated in FIG. 20B.

More specifically, although the shape of the graphics is changed to a trapezoid, the filling method, i.e., horizontal color gradation remains unchanged providing insufficient three-dimensional rendering effects. The present exemplary embodiment provides a method for changing the shape of fill area for each color as illustrated in FIG. 20C.

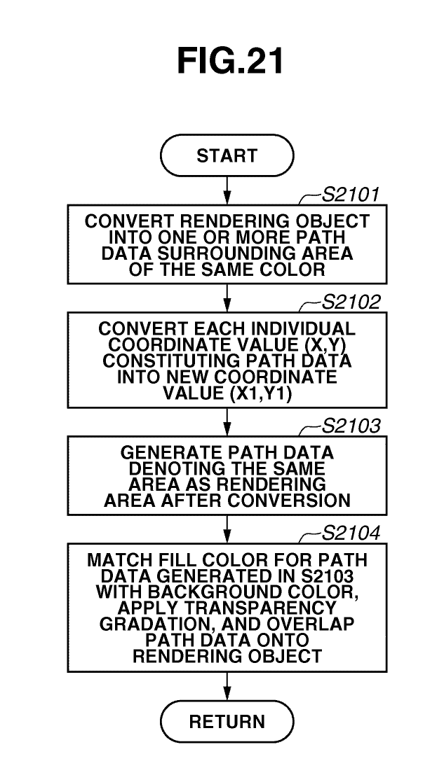

FIG. 21 is a flow chart illustrating processing for rendering a rendering object according to the present exemplary embodiment. As illustrated in FIG. 21, in step S2101, the CPU 101 converts a target rendering object into one or more pieces of path data surrounding areas of the same color. Specifically, the CPU 101 converts the rectangle in FIG. 18A into six pieces of path data or rectangles: “abih”, “bcji”, “cdkj”, “delk”, “efml”, and “fgnm”. The six rectangles are respectively filled with fill colors A, B, C, D, E, and F.

In step S2102, the CPU 101 converts each individual coordinate value constituting each piece of path data into a new coordinate value through the three-dimensional conversion process. The processing of steps S2103 and S2104 is similar to that of steps S404 and S405 in FIG. 4, respectively. After completion of this processing, the rendering result on the screen in FIG. 20C can be obtained, enabling more three-dimensionally expression.

Although, in step S2101, the conversion, in which areas surrounding the same color are converted into one piece of path data, is performed, areas surrounding similar colors in a predetermined range maybe converted into one piece of path data.

For example, an area “abih” and an area “bcji” originally having a different color may be converted into one piece of path data “acjh”, and then my be filled with a neutral color of A and B. Although the image quality of rendering result slightly changes, this processing can reduce the number of coordinates subjected to coordinate conversion in step S2102, thereby attaining higher processing speeds.

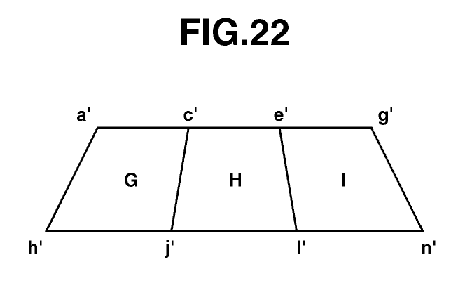

FIG. 22 illustrates rendering result on the screen obtained by applying such conversion in which areas surrounding similar colors are converted into one piece of path data. In FIG. 22, G is a neutral color of A and B, H is a neutral color of C and D, and I is a neutral color of E and F.

A fifth exemplary embodiment will be described below. The configuration of an information processing apparatus according to the fifth exemplary embodiment is the same as that of the information processing apparatus according to the first exemplary embodiment in FIG. 1.

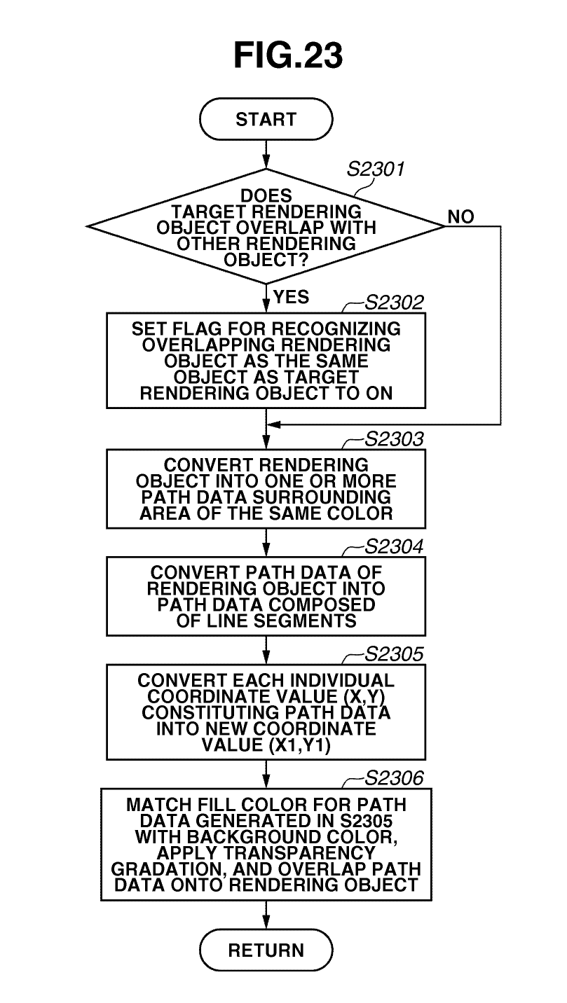

FIG. 23 is a flow chart illustrating processing performed by an information processing apparatus according to the fifth exemplary embodiment. As illustrated in FIG. 23, in step S2301, the CPU 101 determines whether or not the target rendering object overlaps with other rendering objects. When the CPU 101 determines that the target rendering object overlaps with other rendering objects (YES in step S2301), then in step S2302, it sets a flag for recognizing the overlapping rendering object as the same object as the target rendering object to ON.

Specifically, even when the overlapping rendering objects are described as different ones in the SVG data, the CPU 101 subsequently recognizes them as one rendering object. In S2301, when the CPU 101 determines that the target rendering object does not overlap with other rendering objects (NO in step S2301), the processing proceeds to step S2303.

Processing of the steps S2303 to S2306 is the same as that of steps S2101 to S2104 in FIG. 21, respectively.

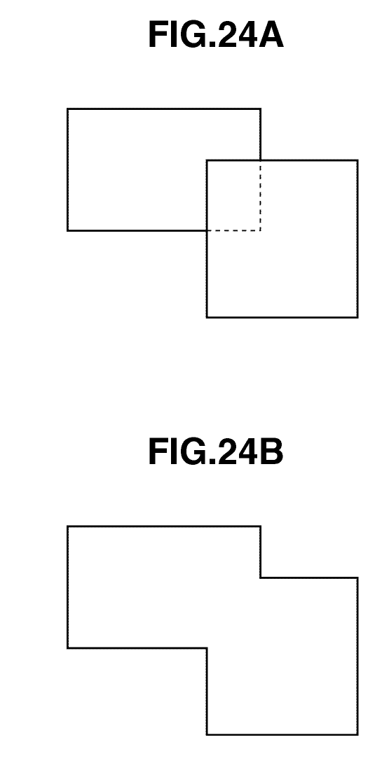

FIGS. 24A and 24B illustrate a change of a rendering object obtained by applying the processing of steps S2302 and S2303. As illustrated in FIG. 24A, there are two different rectangles partially overlapping with each other before applying the processing of step S2302. When these rectangles have the same color, the CPU performs the processing of step S2302 and S2303 to convert them into one piece of path data as illustrated in FIG. 24B.

This processing can reduce the number of rendering objects. Further, in many cases, this processing can reduce the total number of apexes constituting path data. The reduction in the number of apexes reduces the amount of memory consumed as well as the number of coordinates to be subjected to coordinate conversion in step S2304, thus attaining higher processing speeds.

Aspects of the present invention can also be realized by a computer of a system or apparatus (or devices such as a CPU or MPU) that reads out and executes a program recorded on a memory device to perform the functions of the above-described embodiments. Aspects of the present invention can also be realized by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-113026 filed May 7, 2009, which is hereby incorporated by reference herein in its entirety.

What is claimed is:

1. An information processing apparatus, comprising:
a first generation unit configured to generate from vector-based graphics data a first coordinate data group at boundary portions of a first image to be rendered based on the graphics data;
a second generation unit configured to generate a second coordinate data group by applying a graphics conversion rule to the first coordinate data group to transform the first image to obtain a second image; and
an output unit configured to output a second vector-based graphics data group for rendering the second image based on the second coordinate data group.

2. An information processing apparatus, comprising:
a first generation unit configured to generate from vector-based graphics data a first coordinate data group at boundary portions of a first image to be rendered based on the graphics data;
a second generation unit configured to generate a second coordinate data group by applying a graphics conversion rule to the first coordinate data group to transform the first image to obtain a second image; and
a rendering unit configured to render the second image in bitmap form based on the second coordinate data group.

3. The information processing apparatus according to claim 2, wherein the first generation unit generates the first coordinate data group based on attribute values of the vector-based graphics data.

4. The information processing apparatus according to claim 2, wherein the first generation unit generates the first coordinate data group so that areas surrounded by coordinate values of the first coordinate data group are filled with the same single color.

5. The information processing apparatus according to claim 2, wherein the graphics conversion rule performs three-dimensional coordinate conversion on the vector-based graphics data.

6. The information processing apparatus according to claim 2, wherein the first generation unit generates the first coordinate data group at boundary portions of the first image based on a predetermined tolerance rule.

7. The information processing apparatus according to claim 2, wherein the first generation unit generates the first coordinate data group as path data.

8. The information processing apparatus according to claim 2, wherein the vector-based graphics data is line data defined by path information and line width information, and
wherein the first generation unit generates the first coordinate values based on the path information and line width information.

9. The information processing apparatus according to claim 2, further comprising:
a determination unit configured to determine whether the second image is to be rendered as animation based on the graphics data by the rendering unit,
wherein if the determination unit determines that the second image is to be rendered as animation, then the first generation unit does not generate the first coordinate data group for strokes in the graphics data.

10. A method for processing information, comprising:
generating from vector-based graphics data a first coordinate data group at boundary portions of a first image to be rendered based on the graphics data;
generating a second coordinate data group by applying a graphics conversion rule to the first coordinate data group to transform the first image to obtain a second image; and
rendering the second image in bitmap form based on the second coordinate data group.

11. A computer-readable storage medium storing a computer program, which when executed by one or more processors implements a method comprising:
generating from vector-based graphics data a first coordinate data group at boundary portions of a first image to be rendered based on the graphics data;
generating a second coordinate data group by applying a graphics conversion rule to the first coordinate data group to transform the first image to obtain a second image; and
rendering the second image in bitmap form based on the second coordinate data group.
